(19) United States
(12) Patent Application Publication
(10) Pub. No.: US 2007/0053374 A1
(43) Pub. Date: Mar. 8, 2007

(54) Multi-service communication system

(76) Inventor: David Levi, Shoham (IL)

Correspondence Address: WOLF, BLOCK, SCHORR & SOLIS-COHEN LLP, 250 PARK AVENUE, NEW YORK, NY, 10177, US

(21) Appl. No.: 10/552,538

(22) PCT Filed: Apr. 13, 2004
(86) PCT No.: PCT/IL04/00324

§ 371 Date: Oct. 31, 2006

(30) Foreign Application Priority Data
Apr. 16, 2003 (US) 60462982

(51) Int. Cl. H04L 12/28

(52) U.S. Cl. 370/431

(57) ABSTRACT

A network card of a rack system. The card includes a bus interface adapted to connect to a backplane bus of the rack system, a data interface adapted to transmit data signals through the bus interface onto the backplane bus and a controller adapted to periodically generate bandwidth allocation signals indicating allocation of time slots of the backplane bus, and transmitting the allocation signals through the bus interface on the backplane bus, on same bus lines used by the data interface.

### FIELD OF THE INVENTION

The present invention relates to the field of communications and particularly to multi-service communication systems.

### BACKGROUND OF THE INVENTION

Communications are used for many different tasks, including telephone conversations, transmission of video signals, fax documents and Internet web pages. Several different types of networks are used for communications. Synchronous time domain multiplexed (TDM) links carry signals synchronously and are traditionally used for telephone services. Ethernet links carry asynchronous, relatively long, packets. Traditionally, Ethernet links are used in connecting computers to each other. Asynchronous transfer mode (ATM) links carry short cells, which can carry different types of transmissions. Different networks developed in order to provide users with the different services. In recent years, however, many communication service providers want or need to provide all three of these types of services.

Communication service providers generally use rack systems including a plurality of electronic cards for handling the communication needs of a neighborhood of clients. The rack system generally hosts a plurality of line cards which interface with clients or other backhaul systems and one or two (generally for redundancy) trunk cards which interface with the network backbone.

In order to provide service for different types of communication formats, some service providers use different rack systems for the different types of formats. Other service providers use a single rack system with a plurality of buses for the plurality of format types. Some rack systems use a TDM bus with a hybrid multi-switch architecture. The bus is pre-allocated between the various types of traffic and does not accommodate to changing needs of the different formats. Some of these systems, although including different service types in a single box, require separate development of the plurality of different system types, so that the development costs remain relatively high.

U.S. Pat. No. 5,177,737 to Daudelin et al., titled Multipurpose Bus System, the disclosure of which is incorporated herein by reference, describes a complex electrical system in which modular circuit packs are connected by a multipurpose bus. The multipurpose bus includes four leads that are used by a bus controller to notify the circuit packs the current bus type of the bus, according to a predetermined scheme for dividing the bandwidth of the bus.

U.S. Pat. No. 6,501,766 to Chaar et al., the disclosure of which is incorporated herein by reference, describes a communication system in which a number of modules communicate with each other through a shared bus. As in the above systems, the division of the bus is predetermined.

U.S. Pat. No. 5,734,656 to Prince et al., the disclosure of which is incorporated herein by reference, describes using a switching hub having a TDM bus for communicating between different types of line cards (LAN, ATM, token ring). An ATM switch converts data from the different line cards into ATM cells for transmission and converts the data back into their original format upon reception.

### SUMMARY OF THE INVENTION

A broad aspect of some embodiments of the present invention relates to upgrading existing legacy rack systems designed for use with signals of a single format for transmission of signals of a plurality of different formats. The term legacy refers herein to apparatus which is widely employed in the market.

An aspect of some embodiments of the invention relates to dynamic allocation of bandwidth of a backplane bus in a rack system, using in-band instructions. A master unit optionally collects information on the bandwidth needs of line cards in the system and synchronously allocates time slots according to the needs. Optionally, the allocation is performed by in-band transmission on the bus lines used for data transmission. The in-band transmission of the instructions achieves a better utilization rate of the bus. In addition, in band transmission allows simpler use of standard buses planned for static bandwidth allocation. It is noted that the term bandwidth refers herein, as customary in the art, to the capacity of the bus, such that the bandwidth allocation referred to herein may include time division, frequency division, code division and/or any other division of the bus capacity (e.g., a combination of time and frequency).

In some embodiments of the invention, the master periodically transmits an allocation for a plurality of slots on the bus, in a broadcast message. Transmission of the allocation for a plurality of slots together, reduces the bandwidth wasted on allocation messages. A single allocation message is used to instruct a plurality of different cards, on the bandwidth they are to use. In some embodiments of the invention, each allocation message relates to bandwidth of more than 100 μseq, optionally 125 μsec, 256 μsec or 1000 μsec. Optionally, the amount of the bandwidth to which each allocation message relates is configurable. Alternatively or additionally, the amount of the bandwidth to which each allocation message relates is dynamically adjusted by the master for example according to the type of traffic passing on the bus.

In some embodiments of the invention, the signals transmitted on the bus are in accordance with a plurality of different formats, for example, native formats, such as two or more of ATM, native Ethernet, token ring and native TDM samples. The dynamic allocation is optionally performed according to the current bandwidth needs of each of the formats. Optionally, the bandwidth allocation is performed globally based on the bandwidth needs of all the formats, without using separate allocation mechanisms for different formats.

In some embodiments of the invention, the backplane bus comprises a legacy standard bus, which is used in the art for standard ATM DSLAMs and/or Ethernet transmissions. In an exemplary embodiment of the invention, the backplane bus comprises a standard Telecom bus used in SDH/SONET TDM equipment. In other embodiments of the invention, the backplane bus includes an Ethernet bus. Alternatively or additionally, the bus is replaced by a standard cell or star configuration. Further alternatively or additionally, the bus or star are not in accordance with a legacy standard.

In some embodiments of the invention, the dynamic allocation is performed for all the line-cards connected to the rack system. Alternatively or additionally, one or more of the line cards are configured with predetermined portions of the bus bandwidth, and the remaining portions of the bus are allocated dynamically between the remaining line cards. These embodiments may be used for example, in order to incorporate legacy line cards which do not support the present invention, within the same rack with line cards which operate in accordance with the present invention.

Optionally, in some embodiments, the line cards may be divided into two or more groups which are configured with separate portions of the bus bandwidth. In each group, the bandwidth is allocated to specific line cards dynamically. This may be used, for example, in order to have line cards operating in accordance with different signal formats co-exist in the same rack system.

An aspect of some embodiments of the invention relates to dynamic allocation of bandwidth of a backplane bus in a rack system, with an allocation granularity of less than 56 bytes. Optionally, the allocation granularity is equal to or less than eight bytes. In some embodiments of the invention, the allocation granularity is a single byte. In some embodiments of the invention, the granularity is smaller than the header size of packets transmitted on the bus, e.g., less than the Ethernet header size. Such a granularity allows adjustment of the allocation bandwidth to Ethernet packets, which may be of different sizes. In addition, such a granularity allows transmission of a plurality of different formats of signals on the bus, without conversion into standard size cells, e.g., ATM cells.

In some embodiments of the invention, the backplane bus carries packets of different sizes. The term packet refers herein to transmission units transmitted from a same source to a same destination, optionally with a routing header.

An aspect of some embodiments of the invention relates to performing uplink queuing in a rack system including line cards and a network card, in the line cards, under control of the network card. The term uplink refers to the transmission direction from the line cards to the network card. The control of the queuing by the network card optionally includes determining for the line cards from which queue they are to transmit data when they are allocated bandwidth. Optionally, the allocation of the bandwidth is performed together with the control of the queues, i.e., bandwidth is allocated per queue.

Optionally, the network card does not include an up-link queue. The network card optionally times the release of signals from the queues of the line cards, such that there is sufficient bandwidth to forward the signals with minimal buffering (e.g., one or two packets to be transmitted immediately), forming one hop scheduling. Optionally in accordance with these embodiments, a single scheduler is used for the entire uplink transmission of the system. Optionally, the line cards do not have uplink schedulers.

This aspect of the invention may be utilized in a rack system having a backplane bus as well as in a rack system having a star backplane topology.

An aspect of some embodiments of the invention relates to transmitting signals of a plurality of different formats on a backplane bus or star of a rack system, encapsulated in a format using large packets, i.e., above 500 bytes, for example the Ethernet format. When the signals reach their destination in one of the cards at the other end of the backplane bus, the encapsulation is removed. Using the Ethernet encapsulation simplifies the encapsulation as there is no need for packet fragmentation. In addition, the use of Ethernet encapsulation allows operation on legacy Ethernet rack systems.

There is therefore provided in accordance with an exemplary embodiment of the invention, a network card of a rack system, comprising a bus interface adapted to connect to a backplane bus of the rack system, a data interface adapted to transmit data signals through the bus interface onto the backplane bus, and a controller adapted to periodically generate bandwidth allocation signals indicating allocation of time slots of the backplane bus, and transmitting the allocation signals through the bus interface on the backplane bus, on same bus lines used by the data interface.

Optionally, the controller receives need indications from other cards of the rack system through the bus interface and generates the bandwidth allocation signals responsive to the received need indications. Optionally, the controller performs the allocation repeatedly in predetermined intervals. Optionally, the controller performs the allocation repeatedly in intervals of between about 0.125 msec and 1 msec. Optionally, at least two of the allocated time slots have different sizes. Optionally, the controller allocates slots with a size granularity of less than 20 bytes. Optionally, the backplane bus comprises a standard TDM Telecom bus.

Optionally, the allocation signals comprise packets that relate to a plurality of slots. Optionally, the bus interface includes an Ethernet physical layer interface. Optionally, the data interface is adapted to receive signals on the allocated time slots. Optionally, the data interface is adapted to receive signals in accordance with a plurality of different formats.

Optionally, the network card includes a data distributor adapted to forward the received signals according to their format. Optionally, the data distributor identifies the format of received signals by examining a header of an encapsulation packet of the signals and/or the slot in which they were received. Optionally, the controller is adapted to allocate the entire bandwidth of the bus. Alternatively, the controller is adapted to allocate less than the entire bandwidth of the bus.

There is further provided in accordance with an exemplary embodiment of the invention, a network card of a rack system, comprising a bus interface adapted to connect to a backplane bus of the rack system, a data interface adapted to transmit data signals through the bus interface onto the backplane bus and a controller adapted to periodically generate bandwidth allocation signals indicating allocation of time slots of variable size of the backplane bus, and transmitting the allocation signals through the bus interface on the backplane bus.

Optionally, the controller allocates time slots with a granularity smaller than 20 bytes or even 2 bytes. Optionally, the data interface is adapted to receive signals on the allocated time slots. Optionally, the data interface is adapted to receive signals in accordance with a plurality of different formats. Optionally, the signals of the plurality of different formats are encapsulated in packets of a single format.

There is further provided in accordance with an exemplary embodiment of the invention, a network card of a rack system, comprising a link interface adapted to connect to a backplane link of the rack system, a data interface adapted to receive data signals through the link interface from the backplane link, a network bus interface for transmitting data signals received by the data interface onto a network bus and a controller adapted to generate control signals regulating the use of the backplane link, for transmission to other cards connected to the backplane link, the control signals being timed responsive to the bandwidth of the network bus, such that the signals received by the data interface can be forwarded onto the network immediately upon receipt without queuing.

Optionally, the network card does not include a buffer for more than currently handled signals received by the data interface. Optionally, the backplane link comprises a bus or a star.

There is further provided in accordance with an exemplary embodiment of the invention, a line card of a rack system, comprising a bus interface adapted to connect to a backplane bus of the rack system, a memory unit for buffering data signals, an input interface adapted to receive control signals which relate to the order in which signals are to be extracted from the memory unit, from a unit external to the line card; and a data interface adapted to transmit data signals from the memory unit onto the bus interface in an under determined from the received control signals.

Optionally, the memory unit stores data signals in a plurality of queues which differ in their transmission priorities. Optionally, the memory unit stores data signals in a plurality of queues which differ in the signal formats they store. Optionally, the control signals indicate from which queue data signals are to be transmitted. Optionally, the data interface is adapted to transmit signals relating to the amount or types of data currently in the memory.

Optionally, the input interface receives the control signals over the backplane bus.

There is further provided in accordance with an exemplary embodiment of the invention, a rack system, comprising a backplane bus, at least one line card, connected to the backplane bus, which includes a memory unit for queuing data signals; and

a network card, connected to the backplane bus, which controls the order in which signals are transmitted from the memory unit over the backplane bus.

Optionally, the network card does not include an uplink buffer.

There is further provided in accordance with an exemplary embodiment of the invention, a method of transmitting signals on a backplane bus, comprising:

receiving signals in a plurality of formats, by a first card connected to the backplane bus, encapsulating at least some of the signals into a format allowing large packets of a size above 500 bytes, by the first card, transmitting the encapsulated signals to a second card connected to the backplane bus and removing the encapsulation from at least some of the encapsulated signals, by the second card.

Optionally, the plurality of formats include at least one of the TDM format, the ATM format and the token ring format. Optionally, the encapsulating includes adding a header. Optionally, the encapsulating includes encapsulating into the Ethernet format. Optionally, the first card comprises a line card and the second card comprises a network card. Optionally, the method includes forwarding the signals from which the encapsulation was removed, onto a network link. Optionally, the method includes adding an encapsulation to the signals forwarded onto the network link.

There is further provided in accordance with an exemplary embodiment of the invention, a method of upgrading a rack system, comprising providing a rack system including at least one network card and at least one line card, which operate in accordance to a single signal format, replacing the network card with a network card that supports operation in accordance with a plurality of formats and adding one or more line cards which operate in accordance with a method allowing transmission in accordance with a plurality of formats, while leaving in the rack system one or more of the at least one single format line card.

Optionally, the single signal format comprises the TDM format.

Optionally, the single signal format comprises the Ethernet format.

There is further provided in accordance with an exemplary embodiment of the invention, a method of transmitting signals between a line card and a network card, comprising transmitting data signals from the network card to a line card over a downlink communication link, transmitting allocation signals indicating allocation of time slots of the communication link, on same link lines used for transmitting the data signals and transmitting data signals from the line card to the network card in time slots allocated to the line card in the allocation signals. Optionally, the communication link comprises a backplane bus. Optionally, the line card and the network card are not included in a same rack.

### BRIEF DESCRIPTION OF THE DRAWINGS

Particular exemplary embodiments of the invention will be described with reference to the following description of embodiments in conjunction with the figures, wherein identical structures, elements or parts which appear in more than one figure are generally labeled with a same or similar number in all the figures in which they appear, in which:

FIG. 1 is a schematic diagram of a rack system, in accordance with an exemplary embodiment of the invention;

FIG. 2 is a schematic block diagram of a slave scheduler, in accordance with an exemplary embodiment of the invention;

FIG. 3 is a schematic block diagram of a master scheduler, in accordance with an exemplary embodiment of the invention;

FIG. 4 is a schematic illustration of the signals transmitted on an access bus, in accordance with an exemplary embodiment of the invention;

FIG. 5 is a schematic illustration of an exemplary control block, in accordance with an exemplary embodiment of the invention; and

FIG. 6 is a flowchart of acts performed in initializing a newly connected line card, in accordance with an exemplary embodiment of the invention.

### DETAILED DESCRIPTION OF EXEMPLARY EMBODIMENTS

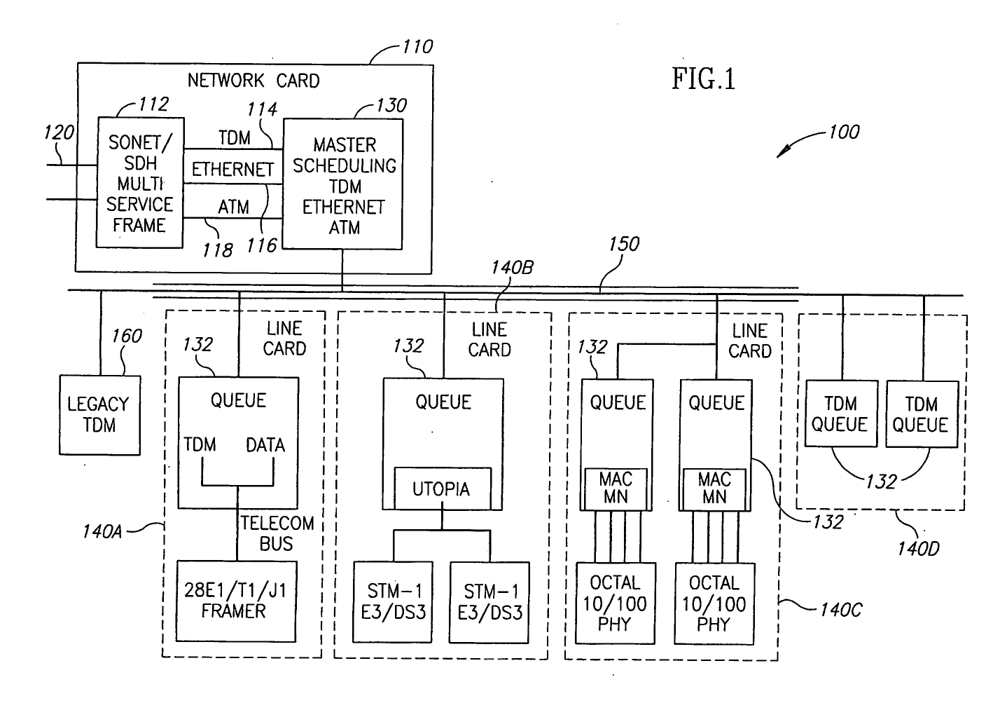

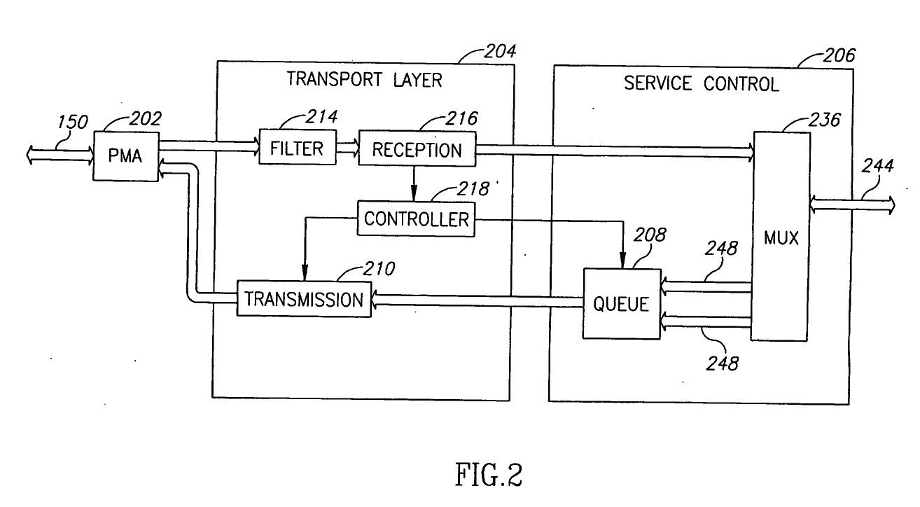

FIG. 1 is a schematic diagram of a rack system 100, in accordance with an exemplary embodiment of the invention. A network card 110 includes a multi service framer 112, for example a SONET or an SDH framer, which transfers signals in various formats onto a network bus 120, as is known in the art. In the example of FIG. 1, framer 112 includes a TDM interface 114, an Ethernet interface 116 and an ATM interface 118. It will be understood that other signal framings may be used, including the token ring format. Network card 110 receives the signals of different formats, over a rack bus 150, from line cards 140 (marked 140A, 140B, etc.) which in turn collect the signals from clients. In addition, signals are passed in the other direction, from network bus 120 to line cards 140. Optionally, each line card 140 handles signals of a single format. Alternatively, one or more line cards 140 handle signals of a plurality of formats, as discussed below with reference to FIG. 2. In FIG. 1, line card 140A handles TDM signals, line card 140B handles ATM signals, line card 140C handles Ethernet signals and line card 140D handles both TDM signals and ATM signals. Optionally, bus 150 may be connected to any number (including zero) of each of the types of line cards 140.

Network card 110 optionally includes a master scheduler 130, which regulates the transmissions on bus 150. Each of line cards 140 optionally includes one or more queue units 132, which operate under the control of master scheduler 130. Master scheduler 130 operates as a single hop scheduler that controls the path from into the line cards 140 to out of network card 110, such that schedulers are not needed in line cards 140. The regulation by master scheduler 130 allows transmission of signals of different formats on the same bus 150, without requiring converting the signals of the different formats into a single bus format and reconverting the signals from the bus formats back into the original formats. As described below, in some embodiments of the invention, instead of performing conversion, the signals of different formats are encapsulated into packets of a single format, such as Ethernet. The encapsulation only requires adding a header and/or a tail, while the conversion may require partitioning large signals into smaller signals and/or queuing.

Optionally, all the scheduling decisions of bus 150 are performed by master scheduler 130. To this end, queue units 132 periodically transmit control signals including status information to master scheduler 130. Master scheduler 130 periodically transmits bandwidth allocation messages to the queue units 132.

In some embodiments of the invention, rack system 100 hosts one or more legacy TDM cards 160, which do not include queue units 132. When cards 140 and/or 160 are installed into rack system 100, an operator optionally configures time portions of the bus to be used by legacy TDM cards 160 and time portions of the bus to be used by line cards 140, using methods known in the art. Thus, in order to perform transmissions in accordance with the present invention, there is no need to replace all the cards 160 of an existing rack system 100. Rather, the legacy network card is replaced by a network card 110 in accordance with the present invention, and one or more line cards 140 are added. Thus, a service provider of TDM voice services can provide Ethernet services simply by purchasing two cards, namely network card 110 and a line card 140 of Ethernet signals.

FIG. 2 is a schematic block diagram of queue unit 132, in accordance with an exemplary embodiment of the invention. Queue unit 132 optionally comprises a physical medium attachment (PMA) unit 202, a transport layer unit 204 and a service control sub-layer 206, as is now described.

Referring to the up link direction of transmitting signals onto bus 150, service control sub-layer (SCS) 206 optionally stores the signals received by the line card 140 in one or more queues in a queue array 208. A controller 218 of transport layer 204 optionally times the release of signals from queue array 208 according to instructions from master scheduler 130 (FIG. 1), received over bus 150. A transmission unit 210 of transport layer 204 receives the signals from queue array 208 and encapsulates the signals into a standard format (e.g., Ethernet frames) for transmission on bus 150. PMA unit 202 adds delineation coding to the transmitted signals and serves as a physical interface to bus 150. The delineation coding may be in accordance with substantially any delineation method, such as byte or fame delineation, e.g., 8b/10b coding.

In the downlink direction, signals received from bus 150 are retrieved by PMA unit 202, which removes the delineation coding, and passes the signals to a filter 214 of transport layer unit 204. Filter 214 determines whether the signals are directed to the line card of queue unit 132 and passes the signals directed to the specific line card to a reception unit 216. Received control signals are provided to transport controller 218, while data signals are converted back to the format of the client to which they are directed.

In some embodiments of the invention, service control sub-layer 206 includes a single bus interface 244 which connects through a multiplexer 236 to a plurality of different buses 248 which lead different types of signals to queue array 208. Alternatively, queue unit 132 services only a single type of signals, in which case multiplexer 236 is not required.

In an exemplary embodiment of the invention, SCS 206 buses 248 include a PCM/Telecom interface for TDM signals, a Utopia interface for ATM signals and an MII interface for Ethernet signals.

In some embodiments of the invention, for simplicity of manufacture, all of queue units 132 include interfaces that support all the types of signal formats supported by rack system 100, with each queue unit 132 activating those interfaces it requires. Alternatively, in order to reduce production costs, each queue unit 132 includes only those interfaces it requires for the line card with which it operates.

In some embodiments of the invention, queue array 208 includes a single queue for each type of signals (e.g., a single queue for Ethernet or ATM and a single queue for TDM). Alternatively, queue array 208 may include, for one or more of the signal formats, a plurality of queues, for example, for signals of different quality of service ratings. The queuing method used may be in accordance with substantially any of the methods known in the art.

Referring in more detail to encapsulating the signals into a specific format, in some embodiments of the invention, the encapsulation is performed with a format allowing large packet, preferably at least as large as the packets of any of the formats serviced by system 100, so that fragmentation is not required in order to perform the encapsulation. Optionally, the header of the encapsulated signals indicates the original format of the signals, so that master scheduler 130 can easily route the signals according to the header.

Alternatively to encapsulating the signals, the signals are transmitted without any encapsulation. This embodiment may be used, for example, with TDM rack buses in which there is no limit on the format of signals which the physical layer of the system can handle. In accordance with this alternative, master scheduler 130 optionally determines the format to which received signals belong according to the slots in which they were received, according to the slot assignment scheme.

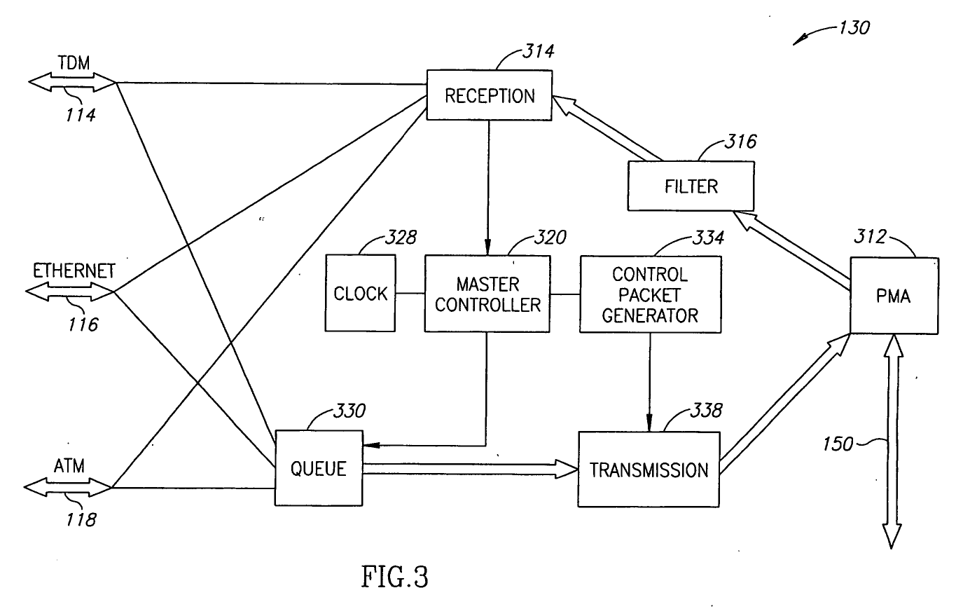

FIG. 3 is a schematic block diagram of master scheduler 130, in accordance with an exemplary embodiment of the invention. As in queue units 132, master scheduler 130 optionally includes a PMA 312 which interfaces with bus 150, adding and removing delimiter signals. Optionally, signals received from bus 150 are transferred to a reception unit 314. In some embodiments of the invention, for example when bus 150 has separate upstream and downstream portions, all the received signals are passed to reception unit 314. Alternatively, for example when bus 150 is not separated between upstream and downstream portions, a filter 316 is used to identify the signals directed to master scheduler 130 and only these signals are passed to reception unit 314.

Control signals received by reception unit 314 are transferred to a master controller 320, which determines the bandwidth needs of each of the line cards and accordingly divides the bandwidth of bus 150 between the line cards. If separate portions of bus 150 are used for uplink and downlink transmissions, master controller 320 optionally determines the scheduling of bus 150 separately for the uplink and the downlink.

In some embodiments of the invention, in which encapsulation is used, reception unit 314 removes the encapsulation of bus 150 from the data signals it receives, and passes them to an appropriate interface (e.g., 114, 116 or 118) according to the type of the signals. Signals received from network bus 120 are optionally placed in a queue array 330. Alternatively, for example when bus 150 has substantially more bandwidth than network bus 120, the signals from bus 120 are immediately transferred to backplane bus 150 without queuing and/or buffering. The signals are optionally released from queue array 330 under instructions of master controller 320. For uplink transmissions, master controller 320 determines a bandwidth allocation of bus 150 between the line cards and instructs a control packet generator 334 to generate control messages to be transmitted to the queue units 132 of the line cards. A transmission unit 338 transmits the control packets from packet generator 334 and the data packets from queue array 330, at times controlled by master controller 320. A clock 328 is optionally used by master controller 320 in timing the transmissions.

In some embodiments of the invention, the signals received by master scheduler 130 from the line cards 140 (i.e., from queue units 132) are not queued by master scheduler 130, but rather are transferred immediately onto the respective interfaces (e.g., 114, 116, 118). Master scheduler 130 optionally times the transmissions from queue units 132 such that queuing in master scheduler 130 is not required. Optionally, the control signals transmitted from master scheduler 130 indicate for each time slot the signals of which queue in queue array 208 are to be transmitted, in order to avoid queuing in master scheduler 130.

Not performing queuing in master scheduler 130 reduces the delay of signals passing through rack system 100 and reduces the memory required for queuing in network card 110.

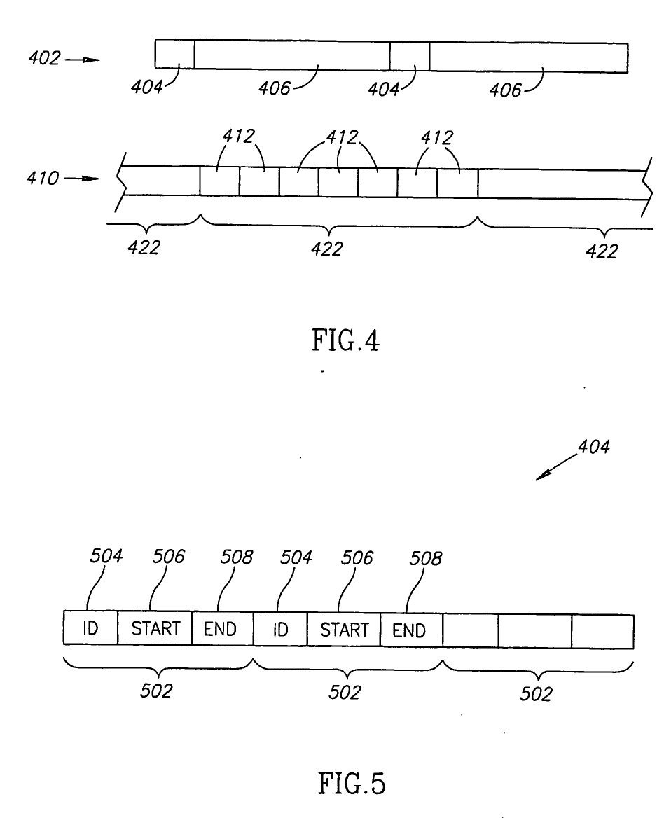

FIG. 4 is a schematic illustration of the signals transmitted on bus 150, in accordance with an exemplary embodiment of the invention. In a downstream direction illustrated by a signal stream 402, master scheduler 130 periodically transmits control blocks 404, which indicate an allocation of a following segment 422 of the upstream (represented by a signal stream 410) of bus 150. Between control blocks 404, master scheduler 130 transmits data signals in payload blocks 406.

Data received by master scheduler 130 for transmission to line cards 140 is optionally appended with an ID associated with the line card to which the data is directed, based on a routing table in master scheduler 130. The data with the appended ID is optionally broadcast on bus 150 to all line cards 140 connected to the bus. Each line card 140 filters the data transmitted in the downlink direction on bus 150 and retrieves data directed to it. For multicast data, an ID identifying the multicast group is optionally used. Optionally, in accordance with these embodiments, the downlink is not slotted and all line cards 140 receive (although do not utilize) all the transmitted data.

Optionally, control blocks 404 are transmitted periodically separated by equal intervals, and the allocated segments 422 are of equal size. In an exemplary embodiment of the invention, segments 422 are of a size of between about 0.1-1 milliseconds (ms), for example 125 microseconds. This size of segments 422 allows a change in the bandwidth allocation of upstream signal stream 410, responsive to real time changes in the needs of line cards, within a short interval which is not noticed by human users or is only slightly noticed by human users. In some embodiments of the invention, the size of segments 422 is pre-configured by a human operator. Optionally, the size of segment 422 is selected from a predetermined number of options, e.g., 0.125 ms, 0.5 ms and 1 ms.

Alternatively to segments 422 of equal sizes, segments 422 are of different sizes, for example according to the type of data transmitted on bus 150. For example, when the signals transmitted on bus 150 are predominantly (or only) non-real-time data signals, long segments 422 are used, while when real time data signals are transmitted, short segments 422 are used. Alternatively or additionally, when there are many changes in the line card bandwidth requirements, shorter segments 422 are used, relative to cases when more stable bandwidth needs are identified.

In some embodiments of the invention, each allocated segment 422 is divided into a number of slots 412 according to the number of line cards connected to bus 150. Optionally, all of slots 412 are of substantially equal size and different allocations are achieved by allocating different numbers of slots. Alternatively, different line cards are assigned slots 412 of different size according to the bandwidth needs of the line cards. Further alternatively, segments 422 are divided into a predetermined number of slots and the slots are assigned according to the needs of each of the line cards. In determining the amount of bandwidth to be allocated, master scheduler 130 optionally takes into account the need to transmit control signals from the line cards to master scheduler 130. In accordance with these embodiments, a single line card may receive different size bandwidth portions in different consecutive segments 422, according to the momentary bandwidth needs and/or entitlement of the line card.

Optionally, each line card is assigned at least one slot 412 in each segment 422 in order to allow the line card to transmit control packets to master scheduler 130. Alternatively, each line card is assigned a slot 412 at least every 2-4 segments 422, optionally according to a quality of service rating of the line card. Alternatively, segments 422 are divided into portions of substantially any size, according to the specific bandwidth needs of each of the line cards and the bandwidth they are to be assigned.

Slots 412 are optionally used by queue units 132 both for transmission of data signals and for transmission of control signals to master scheduler 130. In some embodiments of the invention, queue units 132 give preference to transmission of control signals. Alternatively, master scheduler 130 allocates the line cards separate slots for data signals and for control signals. Further alternatively, master scheduler 130 allocates a single slot 412 for both data and control signals but indicates the amount and/or position of the control data in the slot 412. In some embodiments of the invention, the control signals transmitted from queue units 132 to master scheduler 130 include report signals which provide master scheduler 130 with information on the bandwidth needs of the queue unit 132. Optionally, the report signals include information on the length of the line in each queue of the queue unit 132.

In some embodiments of the invention, master scheduler 130 periodically allocates a public slot for use by queue units 132 which were not assigned a slot 412 within the current segment 422. For example, the public slot may be used by line cards that unexpectedly received urgent data and/or by newly connected line cards. The public slot is optionally very small, in order to reduce to minimum the bandwidth waste, and optionally has a minimal size sufficient for notification by a line card that it requests to be assigned bandwidth.

In accordance with an exemplary embodiment of the invention, the control signals utilize between 1-2% of the bandwidth of bus 150.

In some embodiments of the invention, the slots may have substantially any size according to the momentary needs of the line cards 140, with a relatively small granularity. Optionally a granularity of less than 56 bytes, or less than the size of ATM cells, is used. Furthermore, in some embodiments of the invention, the granularity is less than 16 bytes or even less than eight byes. In some embodiments of the invention, a granularity of a single byte is used.

FIG. 5 is a schematic illustration of an exemplary control block 404, in accordance with an exemplary embodiment of the invention. Control block 404 optionally includes a sequence of allocation blocks 502, each of which includes an ID field 504 identifying the line card to which the allocation block relates. In addition to ID field 504, each allocation block 502 optionally includes a start point field 506, which indicates a beginning point of the bandwidth allocated to the identified line card within segment 422, and an end point field 508, which indicates an ending point of the bandwidth allocated to the identified line card within segment 422.

Alternatively to including end point field 508, a field indicating the length of the allocated bandwidth is used. Control block 404 may include other fields as is known in the art.

In some embodiments of the invention, master scheduler 132 allocates to each line card 140 a portion of the bandwidth of bus 150 according to its needs, without defining the bandwidth assigned to each queue or client of the line card 140. These embodiments are optionally used when fairness of allocation is not important relative to simplicity of master scheduler 130. Alternatively, master scheduler 130 transmits to each queue unit 132 a specific allocation for each queue in the queue array 208 of the queue unit 132 and/or for each client serviced by the line card 140 of the queue unit 132. Thus, controller 218 (FIG. 2) of queue unit 132 can be made relatively simple, as the scheduling is performed by master scheduler 130. In addition, the scheduling is performed more fairly, as all the decisions are performed by a central unit (master scheduler 130) that has all the information.

The performing of the scheduling by master scheduler 130 also allows for simple aggregation of the signals in network card 110. For example, master scheduler 130 can allocate bandwidth for TDM in chunks of the size filling an aggregated packet. In addition, bandwidth for TDM may be allocated when all the line cards 140 together have accumulated data sufficient for a TDM chunk.

Alternatively to master scheduler 130 transmitting a specific allocation for each queue, master scheduler 130 transmits a general rule as to which signals are to be transmitted on bus 150 and/or which signals are to be discarded. Queue unit 132 then divides the bandwidth it is allocated between its queues and/or clients according to the general rule. Optionally, the general rule pertains to all the line cards 140 connected to bus 150. Alternatively, different line cards 140 are assigned different rules for allocating their bandwidth (including slots and any other bus capacity sub-units) between their clients and/or queues.

The general rule optionally indicates a percentage of signals which are to be transmitted for each client, based on the load on bus 150. For example, if the demand for bandwidth is twice the available bandwidth of bus 150, each line card 140 is optionally instructed to forward only half of the signals of each client.

In some embodiments of the invention, the general rule transmitted to the line cards 140 relates to the terms of the service level agreements (SLAs) of the clients. Optionally, for each client, the bandwidth range between the committed bandwidth (i.e., bandwidth the client is promised to receive under all circumstances), referred to also as green bandwidth, and the maximal allocated bandwidth which the client may receive is divided into a plurality of sub levels, referred to as levels of yellow bandwidth. Based on the available bandwidth, master scheduler 130 transmits an instruction on a sub level of yellow bandwidth above which signals are to be discarded. Each queue unit 132 optionally keeps track of the signal transmission rate of each client, relative to its yellow level bandwidth, and when the client provides signals at a rate above the instructed sub-level from queue unit 132, the excess signals are discarded. In some embodiments of the invention, queue units 132 do not request bandwidth allocation for data signals above the instructed sub-level.

In some embodiments of the invention, as described above, queue units 132 periodically transmit to master scheduler 130 information on the data in its queues. Optionally, the transmitted information includes the number of signals of each type that the line card 140 has accumulated over the most recent segment. Alternatively or additionally, the transmitted information includes the number of signals accumulated from each client.

Alternatively or additionally to queue units 132 periodically transmitting information regarding the required bandwidth to master scheduler 130, queue units 132 mark each data signal they transmit to master scheduler 132 with a color indication of the sub level indicative of the current bandwidth utilization of the client from which the data was received. Using the color indications from the clients, master scheduler 130 determines a sub-level which will achieve a fair allocation of the bandwidth.

In some embodiments of the invention, the periodic information transmitted by queue units 132 indicates the general bandwidth needs of the line card 140, while the general rule for dividing the bandwidth between the clients of the line card is determined from the color indications of the transmitted data. In some embodiments of the invention, the indication of the general bandwidth required by a line card 140 relates only to data which is not to be discarded according to the currently effective general rule.

The yellow bandwidth is optionally divided into between 32-64 sub-levels. Optionally, all the sub-levels are defined at equal distances along the yellow bandwidth. Alternatively, larger bandwidth sub-level steps are defined closer to the ends of the yellow bandwidth, while smaller steps are defined toward the center of the yellow bandwidth.

Optionally, each control signal transmitted between master scheduler 130 and a queue unit 132 carries a time stamp which is used to synchronize the times of queue units 132 with the time of master scheduler 130. In some embodiments of the invention, also the data signals carry time stamps, such that the synchronizing of the time is performed continuously at a high rate. The control signals may optionally be appended to data signals so that there is no need to allocate separate slots for control signals. In some embodiments of the invention, in stating the time in start point field 506, master scheduler 130 adjusts the time according to the round trip delay of signals between master scheduler 130 and the queue unit 132 to compensate for the time difference between the master and slave schedulers. The adjustment is optionally performed using any method known in the art. Alternatively, when the round trip delay on bus 150 is very short, no adjustment of the time is performed.

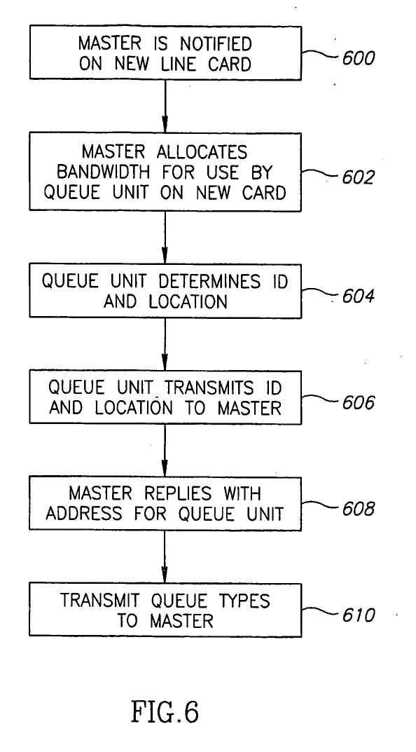

FIG. 6 is a flowchart of acts performed in initializing a newly connected line card, in accordance with an exemplary embodiment of the invention. When master scheduler 130 is notified (600) of the existence of the newly connected line card, master scheduler 130 allocates (602) the line card (referred to herein without loss of generality as 40) a bandwidth portion sufficient to conduct the following initialization process. Queue unit 132 determines (604) its initial module ID and its module location and transmits (606) the determined ID and location to master scheduler 130. Master scheduler 130 optionally replies (608) with an address allocation. Queue unit 132 transmits (610) to master scheduler 130 an indication of the types of queues it uses. Optionally, the transmissions exchanged between master scheduler 130 and queue unit 132, for initialization, are used for round trip delay measurement. Alternatively or additionally, the initialization includes an authentication and/or registration process, which prevents incompatible units from connecting onto bus 150.

Optionally, if during operation any of the initialization information changes, queue unit 132 transmits a control packet with the changing information to master scheduler 130.

In some embodiments of the invention, master scheduler 130 is notified (600) automatically on the existence of the newly connected line card by the line card, which transmits a notification in bandwidth allocated for general use. Alternatively or additionally, master scheduler 130 is configured with the existence of the newly connected line card, by a human operator.

It is noted that although the above description uses the term bus, the present invention may be used on other common communication links, such as star links. Optionally, in a star configuration, instead of broadcasting downlink data on bus 150, the data is transmitted only to the destined card 140, or for multicast data to the destined cards 140. Furthermore, the present invention may be used in a multi-point to multi-point switch on each of the links of the switch. Optionally, for each link of the switch, one of the cards connected to the link operates as a master.

In some embodiments of the invention, the principles of the present invention are performed in a cascaded system. Optionally, master scheduler 130 is located in a first rack, which is connected through some of its line cards to one or more other racks. Queue units 132 are located in the line cards 140 of the other racks, while the lien cards in the first rack perform transparent forwarding of the packets in the uplink and/or downlink directions.

It has been mentioned above that the present invention can be implemented in a rack system that still includes legacy TDM cards. In a similar manner, the present invention can be implemented in racks using other types of legacy cards, such as Ethernet cards. In some embodiments of the invention, the present invention can be implemented in a rack system having legacy cards of a plurality of different types. The bus of the rack system is optionally divided between the cards of the different types using a pre-configured division.

It is noted that in some cases network card 110 may be connected to a conversion unit, for converting the signals into a single format (e.g., ATM) at its output to bus 120. Performing the conversion after network card 110, rather than at each of line cards 140 (so that a single type bus can be used), allows for less delay since the signals may be aggregated at network card 110, before the conversion.

It will be appreciated that the above described methods may be varied in many ways. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. For example, the order of acts in FIG. 6 is by way of example and the signals may be exchanged in essentially any other suitable order. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A destination card of a rack system, comprising:
a physical link interface adapted to connect to a backplane link of the rack system;
a data interface adapted to transmit data signals through the link interface onto downlink lines of the backplane link; and
a controller adapted to periodically determine a bandwidth allocation of time slots of uplink lines of the backplane link to data signals of a plurality of different formats, and adapted to transmit bandwidth allocation signals indicating the determined allocation through the link interface on same backplane link lines on which the data interface transmits data signals.

2. A card according to claim 1, wherein the controller receives need indications from other cards of the rack system through the link interface and generates the bandwidth allocation signals responsive to the received need indications.

3. A card according to claim 1, wherein the controller performs the allocation repeatedly in predetermined intervals.

4. A card according to claim 1, wherein the controller performs the allocation repeatedly in intervals of between about 0.125 msec and 1 msec.

5. A card according to claim 1, wherein at least two of the allocated time slots have different sizes.

6. (canceled)

7. A card according to claim 49, wherein the backplane bus comprises a standard TDM Telecom bus.

8. A card according to claim 1, wherein the allocation signals comprise packets that relate to a plurality of slots.

9. A card according to claim 1, wherein the link interface includes an Ethernet physical layer interface.

10. (canceled)

11. A card according to claim 10, wherein the data interface is adapted to receive signals in accordance with a plurality of different formats.

12. A card according to claim 11, comprising a data distributor adapted to forward the received signals according to their format.

13. A card according to claim 12, wherein the data distributor identifies the format of received signals by examining a header of an encapsulation packet of the signals.

14. A card according to claim 12, wherein the data distributor identifies the format of received signals according to the slot in which they were received.

15-20. (canceled)

21. A card according to claim 1, wherein the data interface is adapted to receive signals in accordance with a plurality of different formats.

22. A card according to claim 21, wherein the signals of the plurality of different formats are encapsulated in packets of a single format.

23. A network card according to claim 1, comprising:
a network bus interface for transmitting data signals received by the data interface onto a network bus, and wherein the controller is adapted to generate control signals regulating the use of the backplane link, for transmission to other cards connected to the backplane link, the control signals being timed responsive to the bandwidth of the network bus, such that the signals received by the data interface can be forwarded onto the network immediately upon receipt without queuing.

24. A network card according to claim 23, wherein the destination card does not include a buffer for more than currently handled signals received by the data interface.

25. A network card according to claim 23, wherein the backplane link comprises a bus.

26. A network card according to claim 23, wherein the backplane link comprises a star configuration link.

27-34. (canceled)

35. A method of transmitting signals on a backplane bus, comprising:
receiving signals in a plurality of formats, by a first card connected to the backplane bus;
encapsulating at least some of the signals into a format allowing large packets of a size above 500 bytes, by the first card;
transmitting the encapsulated signals to a second card connected to the backplane bus; and
removing the encapsulation from at least some of the encapsulated signals, by the second card.

36. A method according to claim 35, wherein the plurality of formats include at least one of the TDM format, the ATM format and the token ring format.

37. A method according to claim 35, wherein the encapsulating includes adding a header.

38. A method according to claim 35, wherein the encapsulating includes encapsulating into the Ethernet format.

39. A method according to claim 35, wherein the first card comprises a line card and the second card comprises a network card.

40. A method according to claim 35, comprising forwarding the signals from which the encapsulation was removed, onto a network link.

41. A method according to claim 35, comprising adding an encapsulation to the signals forwarded onto the network link.

42. A method of upgrading a rack system, comprising:
providing a rack system including at least one network card and at least one line card, which operate in accordance to a single signal format;
replacing the network card with a network card that supports operation in accordance with a plurality of formats; and
adding one or more line cards which operate in accordance with a method allowing transmission in accordance with a plurality of formats, while leaving in the rack system one or more of the at least one single format line card.

43. A method according to claim 42, wherein the single signal format comprises the TDM format.

44. A method according to claim 42, wherein the single signal format comprises the Ethernet format.

45. A method of transmitting signals, comprising:
transmitting data signals from a destination card to a source card over a downlink communication link;
transmitting allocation signals indicating allocation of time slots of the communication link, on same link lines used for transmitting the data signals from the destination card to the source card; and
transmitting data signals from the source card to the destination card in time slots allocated to the source card in the allocation signals.

46. A method according to claim 45, wherein the communication link comprises a backplane bus.

47. A method according to claim 45, wherein the source card and the destination card are not included in a same rack.

48. A method according to claim 45, wherein transmitting the data signals comprises transmitting signals of a plurality of different formats.

49. A card according to claim 1, wherein the backplane link comprises a backplane bus.

50. A card according to claim 1, wherein the backplane link comprises a star configuration link.

51. A card according to claim 1, wherein the controller is adapted to allocate slots of a plurality of different sizes.

52. A card according to claim 51, wherein the controller is adapted to select the sizes of the allocated slots responsive to the types of signals the slots are to carry.

53. A card according to claim 1, wherein the bandwidth allocation signals identify the types of signals to be transmitted in at least some of the slots.

54. A card according to claim 1, wherein the bandwidth allocation signals identify, for at least some slots, a specific queue to receive the slot.

55. A card according to claim 1, wherein the bandwidth allocation signals indicate a general rule with instructions on how the slots allocated to a source card are to be divided between clients of the source card.

56. A card according to claim 55, wherein the bandwidth allocation signals indicate when signals of a client are to be discarded.

57. A card according to claim 55, wherein each client of the source card has an agreed green bandwidth provided at all times and an allocated yellow bandwidth provided when available, and wherein the bandwidth allocation signals indicate a percentage of the agreed yellow bandwidth to be allocated to the clients.

58. A rack system, comprising:
a chassis including a backplane link;
a destination card according to claim 1; and
a plurality of source cards, adapted to transmit to the destination card over the backbone link, data signals in accordance with a plurality of different formats.
